(19) United States
(12) Patent Application Publication
(10) Pub. No.: US 2016/0379619 A1
(43) Pub. Date: Dec. 29, 2016

(54) WIRELESS AIRCRAFT, METHOD OF CANCELLING NOISE, PROGRAM FOR WIRELESS AIRCRAFT

(71) Applicant: OPTiM Corporation, Saga (JP)

(72) Inventor: Shunji SUGAYA, Tokyo (JP)

(21) Appl. No.: 14/938,932

(22) Filed: Nov. 12, 2015

(30) Foreign Application Priority Data
Jun. 26, 2015 (JP) 2015-128437

(51) Int. Cl. G10K 11/178

(52) U.S. Cl. CPC G10K 11/1782; G10K 2210/30231; G10K 2210/1281

(57) ABSTRACT

The present invention is to provide a wireless aircraft, a method of cancelling noise, and a program for the wireless aircraft, which are capable of maintaining the flight performance of the aircraft and decreasing noises. The wireless aircraft 10 having a motor and a propeller, in which the motor rotates the propeller, collects a motor-rotating sound from the motor and generates an antiphase sound wave against the collected motor-rotating sound, collects a marginal sound, and cancels noise by synthesizing the antiphase sound wave against the collected motor-rotating sound with the collected motor-rotating sound.

### CROSS REFERENCE TO RELATED APPLICATIONS

This application claims priority to Japanese Patent Application No. 2015-128437 filed on Jun. 26, 2015, the entire contents of which are incorporated by reference herein.

### TECHNICAL FIELD

The present invention relates to a wireless aircraft having a motor and a propeller, in which the motor rotates the propeller, a method of cancelling noise, and a program for the wireless aircraft.

### BACKGROUND ART

Recently, wireless aircrafts having a motor and a propeller, in which the motor rotates the propeller, have been put to practical use. Such wireless aircrafts collect sounds while flying in the air.

Such wireless aircrafts collect undesired sounds such as motor-rotating sounds generated by rotating the propeller while flying in the air. In other words, the motor-rotating sounds mingle in the collected sounds as noises.

Although differing from wireless aircrafts, a method of decreasing noises other than desired sounds has been disclosed, in which antiphase sound waves against the noises are generated to decrease the noises (refer to Patent Document 1).

### CITATION LIST

### Patent Literature

Patent Document 1: JP 2012-118334 A

### SUMMARY OF INVENTION

According to Patent Document 1, ambient noises are collected, and antiphase sound waves against the collected ambient noises are generated and output from a first speaker to a predetermined space. In addition, antiphase sound waves against sounds collected from a speaker which is different from the first speaker are generated and output from a second speaker to a microphone. As a result, the collected ambient noises can be decreased.

However, the method described in Patent Document 1 requires two or more speakers to decrease noises. This increases not only the cost but also the weight of the device to decrease the flight performance.

The inventor has found that noises generated by a motor can be decreased by synthesizing antiphase sound waves against the noises.

An objective of the present invention is to provide a wireless aircraft, a method of cancelling noise, and a program for the wireless aircraft, which are capable of maintaining the flight performance of the aircraft and decreasing noises.

According to the first aspect of the present invention, a wireless aircraft having a motor and a propeller, the motor rotating the propeller, includes:

an antiphase sound wave generation unit that collects a motor-rotating sound from the motor and that generates an antiphase sound wave against the collected motor-rotating sound;

a microphone unit that collects a marginal sound; and

a noise cancellation unit cancels noise by synthesizing the antiphase sound wave against the collected motor-rotating sound with the marginal sound collected by the microphone unit.

According to the first aspect of the present invention, a wireless aircraft having a motor and a propeller, the motor rotating the propeller collects a motor-rotating sound from the motor and generates an antiphase sound wave against the collected motor-rotating sound, collects a marginal sound, and cancels noise by synthesizing the antiphase sound wave against the collected motor-rotating sound with the collected motor-rotating sound.

The first aspect of the invention belongs to the category of a wireless aircraft but has the same working effects under different categories such as a method of cancelling noise and a program for a wireless aircraft.

According to the second aspect of the present invention, in the wireless aircraft according to the first aspect of the present invention, the antiphase sound wave generation unit generates an antiphase sound wave against a previously stored motor-rotating sound.

According to the second aspect of the present invention, the wireless aircraft according to the first aspect of the present invention generates an antiphase sound wave against a previously stored motor-rotating sound.

According to the third aspect of the present invention, a method of cancelling noise executed by a wireless aircraft having a motor and a propeller, the motor rotating the propeller includes the steps of:

collecting a motor-rotating sound from the motor and generating an antiphase sound wave against the collected motor-rotating sound;

collecting a marginal sound; and

cancelling noise by synthesizing the antiphase sound wave against the collected motor-rotating sound with the marginal sound collected by the microphone unit.

According to the fourth aspect, a computer program product for use in a wireless aircraft having a motor and a propeller, the motor rotating the propeller, comprising a non-transitory computer usable medium having a set of instructions physically embodied therein, the set of instructions including computer readable program code, which when executed by the wireless aircraft causes the information processing unit to:

collect a motor-rotating sound from the motor and generate an antiphase sound wave against the collected motor-rotating sound;

collect a marginal sound; and

cancel noise by synthesizing the antiphase sound wave against the collected motor-rotating sound with the marginal sound collected by the microphone unit.

The present invention is to provide a wireless aircraft, a method of cancelling noise, and a program for the wireless aircraft, which are capable of maintaining the flight performance of the aircraft and decreasing noises.

### BRIEF DESCRIPTION OF DRAWINGS

FIG. 1 is the conceptual diagram of the wireless aircraft 10 according to the first embodiment.

FIG. 2 is the conceptual diagram of the wireless aircraft 10 according to the second embodiment.

FIG. 3 is the functional block diagram of the wireless aircraft 10.

FIG. 4 is a flow chart showing the noise cancellation process executed by the wireless aircraft 10 according to the first embodiment.

FIG. 5 is a flow chart showing the noise cancellation process executed by the wireless aircraft 10 according to the second embodiment.

### DESCRIPTION OF EMBODIMENTS

Hereinafter, a preferable mode of the present invention will be described below with reference to the accompanying drawings. However, this is illustrative only, and the scope of the present invention is not limited thereto.

### Wireless Aircraft 10 According to First Embodiment

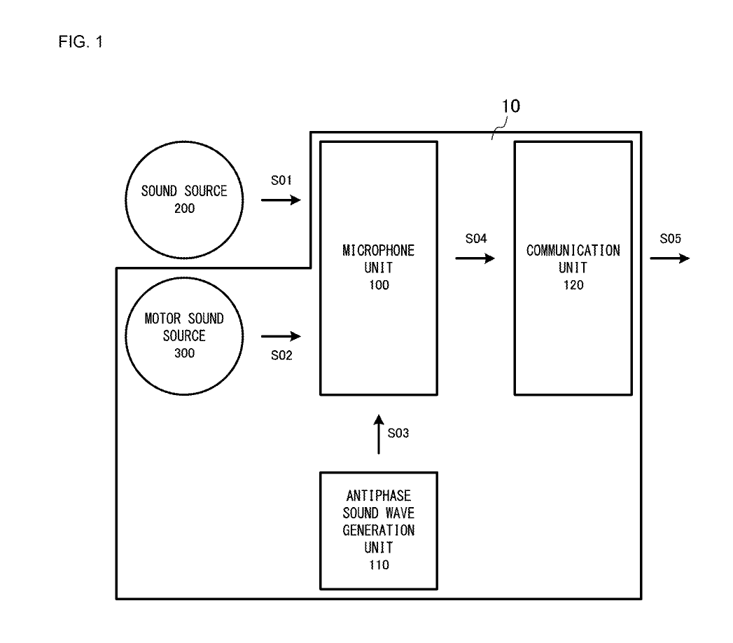

The present invention according to the first embodiment will be explained with reference to FIG. 1. The wireless aircraft 10 includes a microphone unit 100, an antiphase sound wave generation unit 110, and a communication unit 120. The wireless aircraft 10 is an uninhabited airborne vehicle that is remotely controllable from an external terminal such as an operation terminal or computer and that is automatically controllable based on a predetermined action programmed inside the vehicle itself. The wireless aircraft 10 flies in the air with a propeller rotated by a motor.

The wireless aircraft 10 collects a marginal sound from the microphone unit 100 to be described later by using the microphone unit 100. The microphone unit 100 collects a sound from a sound source 200 and a motor sound source 300. The sound from the sound source 200 comes from a place specified based on a remote request or a predetermined programmed action. The sound from the motor sound source 300 comes from a motor rotating a propeller of the wireless aircraft 10.

The microphone unit 100 includes a device collecting the sound from the sound source 200 and a device collecting the sound from the motor sound source 300 based on a remote request or a predetermined programmed action. The communication unit 120 includes a device transmitting and receiving short-range wireless communication signals and radio waves in a prescribed band.

First, the wireless aircraft 10 collects a sound from the sound source 200 by using the microphone unit 100 based on a remote request or a predetermined programmed action (step S01).

At the same time, the wireless aircraft 10 also collects a motor-rotating sound from the motor sound source 300 by using the microphone unit 100 (step S02).

The wireless aircraft 10 analyzes the motor-rotating sound collected from the motor in the step S02 by using the antiphase sound wave generation unit 110, generates an antiphase sound wave against the analyzed motor-rotating sound, and outputs the antiphase sound wave to the microphone unit 100 (step S03).

The wireless aircraft 10 synthesizes the sound collected from the sound source 200 in the step S01 with the antiphase sound wave generated in the step S03 to perform noise cancellation (step S04). In the step S04, since the sound collected from the sound source 200 is synthesized with the antiphase sound wave against the motor-rotating sound, the motor-rotating sound mingling in the sound from the sound source 200 can be cancelled.

The wireless aircraft 10 transmits the sound data after performing the noise cancellation in the step S04 to an external terminal by using the communication unit 120 (step S05).

### Wireless Aircraft 10 According to Second Embodiment

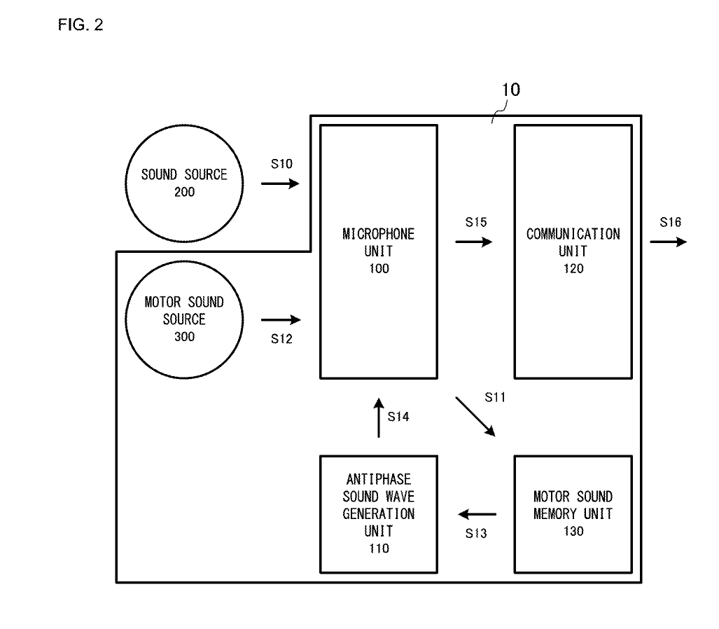

The present invention according to the second embodiment will be explained with reference to FIG. 2. The wireless aircraft 10 includes a microphone unit 100, an antiphase sound wave generation unit 110, a communication unit 120, and a motor sound memory unit 130. The wireless aircraft 10 is an uninhabited airborne vehicle that is remotely controllable from an external terminal such as an operation terminal or computer and that is automatically controllable based on a predetermined action programmed inside the vehicle itself. The wireless aircraft 10 flies in the air with a propeller rotated by a motor.

The wireless aircraft 10 collects a marginal sound from the microphone unit 100 to be described later by using the microphone unit 100. The microphone unit 100 collects a sound from a sound source 200 and a motor sound source 300. The sound from the sound source 200 comes from a place specified by a remote request or a predetermined programmed action. The sound from the motor sound source 300 comes from a motor rotating a propeller of the wireless aircraft 10.

The microphone unit 100 includes a device collecting the sound from the sound source 200 and a device collecting the sound from the motor sound source 300 based on a remote request or a predetermined programmed action. The communication unit 120 includes a device transmitting and receiving short-range wireless communication signals and radio waves in a prescribed band. The motor sound memory unit 130 includes a device storing the sound collected from the motor sound source 300.

First, the wireless aircraft 10 collects a motor-rotating sound from the motor sound source 300 by using the microphone unit 100 (step S10). In the step S10, the microphone unit 100 collects a motor-rotating sound from a motor rotating a propeller as the sound from the motor sound source 300.

The wireless aircraft 10 stores the sound collected from the motor sound source 300 in the step S10 by using the motor sound memory unit 130 (step S11).

Then, the wireless aircraft 10 collects a sound from the sound source 200 by using the microphone unit 100 (step S12).

The wireless aircraft 10 obtains the motor-rotating sound stored in the step S11 by using the antiphase sound wave generation unit 110 (step S13), generates an antiphase sound wave against the obtained motor-rotating sound, and outputs the generated antiphase sound wave to the microphone unit 100 (step S14).

The wireless aircraft 10 synthesizes the sound collected from the sound source 200 in the step S12 with the antiphase sound wave generated in the step S14 to perform noise cancellation (step S15). In the step S15, since the sound collected from the sound source 200 is synthesized with the antiphase sound wave against the motor-rotating sound, the motor-rotating sound mingling in the sound from the sound source 200 can be cancelled.

The wireless aircraft 10 transmits the sound data after performing the noise cancellation in the step S15 to an external terminal by using the communication unit 120 (step S16).

### Functions

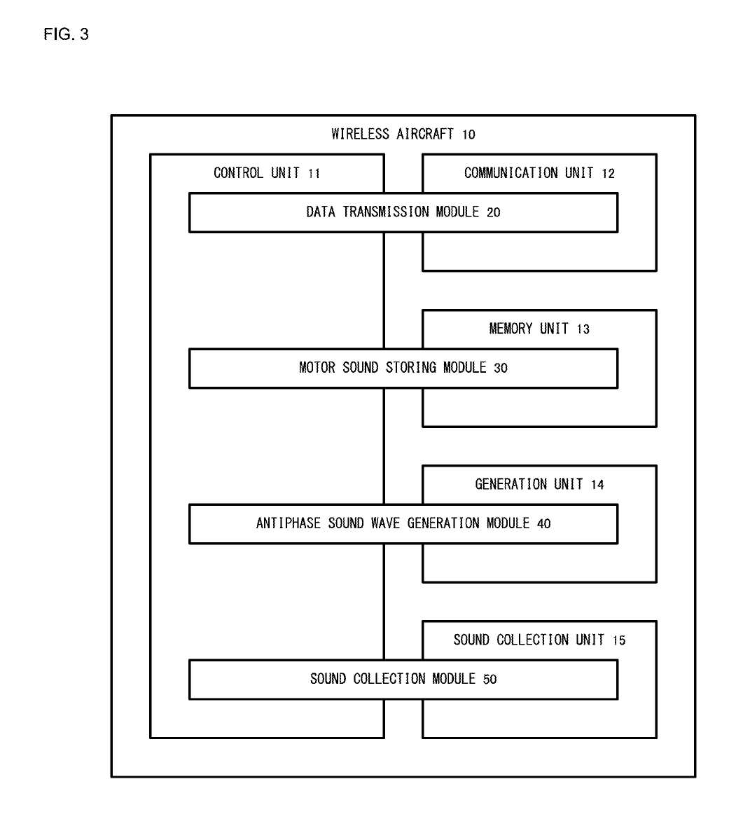

The configuration of the wireless aircraft 10 will be explained with reference to FIG. 3. The wireless aircraft 10 has the function described below to fly in the air with a propeller rotated by a motor and collect a marginal sound by using a microphone, etc.

The wireless aircraft 10 is provided with a control unit 11 including a central processing unit (hereinafter referred to as “CPU”), a random access memory (hereinafter referred to as “RAM”), and a read only memory (hereinafter referred to as “ROM”); and a communication unit 12 including a Wi-Fi® enabled device complying with, for example, IEEE 802.11, a short-range wireless communication device such as an infrared communication device, and a device for transmitting and receiving radio wave in a predetermined band.

The wireless aircraft 10 also includes a memory unit 13 such as a hard disk, a semiconductor memory, a recording medium, or a memory card for storing data. The memory unit 13 stores the motor-rotating sound from the wireless aircraft 10 to be described later. The wireless aircraft 10 also includes a generation unit 14 such as a device generating an antiphase sound wave against the motor-rotating sound to be described later. The wireless aircraft 10 also includes a sound collection unit 15 such as a microphone device collecting a marginal sound.

In the wireless aircraft 10, the control unit 11 reads a predetermined program and runs a data transmission module 20 in cooperation with the communication unit 12. Furthermore, the control unit 11 reads a predetermined program and runs a motor sound storing module 30 in cooperation with the memory unit 13. Still furthermore, the control unit 11 reads a predetermined program and runs an antiphase sound wave generation module 40 in cooperation with the generation unit 14. Yet still furthermore, the control unit 11 reads a predetermined program and runs a sound collection module 50 in cooperation with the sound collection unit 15.

### Noise Cancellation Process in First Embodiment

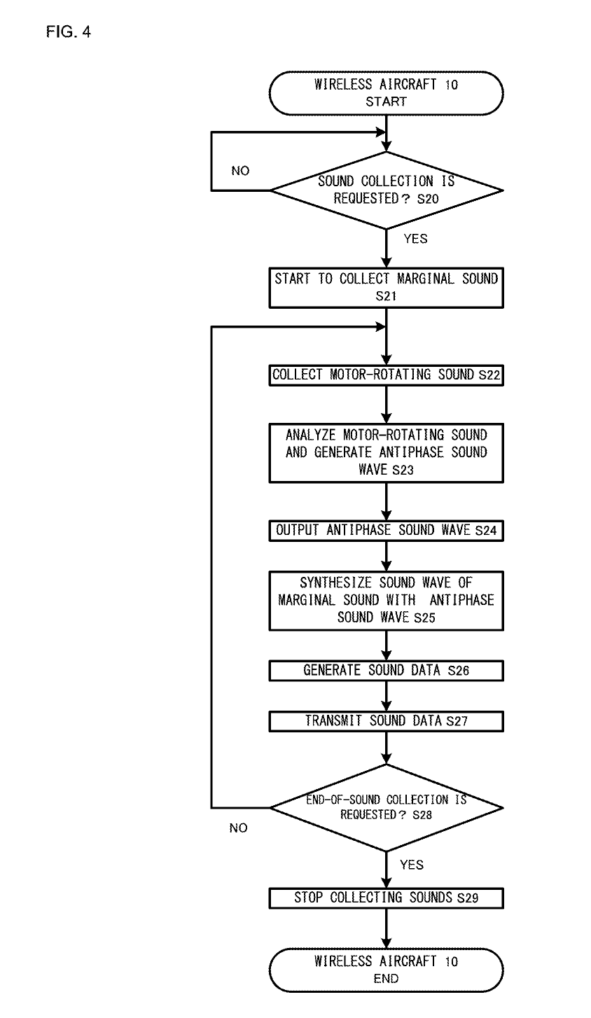

FIG. 4 is a flow chart showing the noise cancellation process executed by the wireless aircraft 10 according to the first embodiment. The tasks executed by the modules will be described below with this process.

First, the sound collection module 50 determines whether or not the module has received a request of sound collection (step S20). In the step S20, the sound collection module 50 determines whether or not the module has received a request of sound collection from an external terminal such as an operation terminal or computer.

In the step S20, if determining that the sound collection module 50 has not received a request of sound collection (NO), the sound collection module 50 repeats this determination process until receiving the request.

If determining that the sound collection module 50 has received a request of sound collection (YES) in the step S20, the sound collection module 50 starts to collect a marginal sound (step S21). In the step S21, when starting to collect a marginal sound, the sound collection module 50 may also start to take images such as still or moving images around the wireless aircraft. In this case, when stopping collecting a marginal sound, the sound collection module 50 only has to stop taking the images.

At the same time, the sound collection module 50 collects a motor-rotating sound from a motor rotating a propeller (step S22).

The antiphase sound wave generation module 40 analyzes the motor-rotating sound collected by the sound collection module 50 and generates an antiphase sound wave against the analyzed sound (step S23).

The antiphase sound wave generation module 40 outputs the generated antiphase sound wave to around a microphone (step S24).

The sound collection module 50 synthesizes the sound wave of the collected marginal sound with the antiphase sound wave generated in the step S23 (step S25), eliminates the motor-rotating sound from the collected marginal sound, and generates sound data (step S26).

The data transmission module 20 transmits the sound data generated in the step S26 to the external terminal (step S27).

The sound collection module 50 determines whether or not the module has received a request of end-of-sound collection (step S28). In the step S28, the sound collection module 50 determines whether or not the module has received a request of end-of-sound collection from an external terminal. In the step S28, the wireless aircraft 10 may generate a request of end-of-sound collection based on a previously set program, etc., in the case, for example, where a predetermined time has passed since sound collection is started or where the wireless aircraft has moved a predetermined distance since sound collection is started.

In the step S28, if determining that the sound collection module 50 has not received a request of end-of-sound collection (NO), the sound collection module 50 repeats the steps from S22 to S27.

If determining that the sound collection module 50 has received a request of end-of-sound collection (YES) in the step S28, the sound collection module 50 stops collecting any sounds (step S29)

### Noise Cancellation Process in Second Embodiment

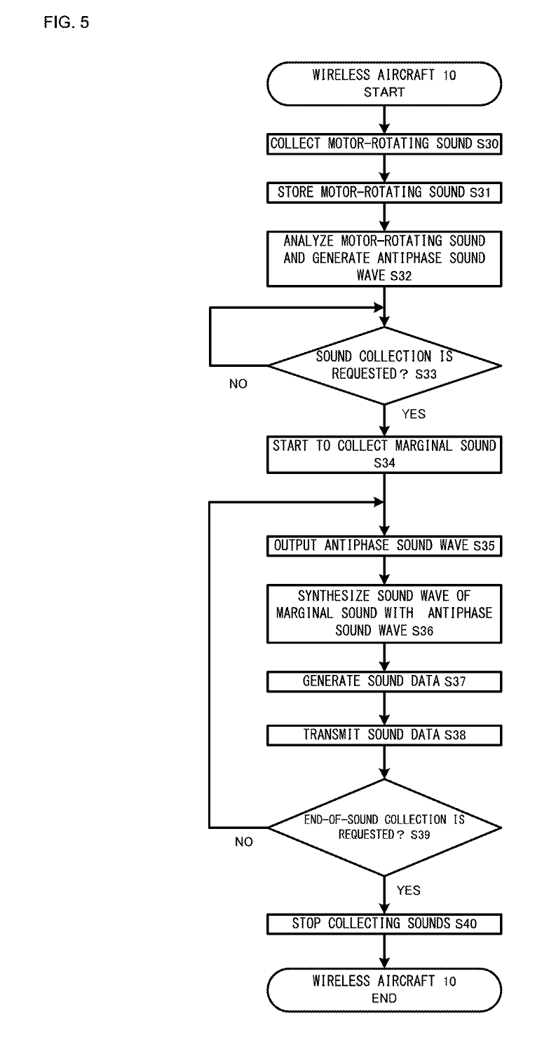

FIG. 5 is a flow chart showing the noise cancellation process executed by the wireless aircraft 10 according to the second embodiment. The tasks executed by the modules will be described below with this process.

First, the sound collection module 50 collects a sound from a motor rotating a propeller (step S30).

The motor sound storing module 30 stores the collected motor-rotating sound (step S31).

The antiphase sound wave generation module 40 analyzes the stored motor-rotating sound and generates an antiphase sound wave against the analyzed sound (step S32).

Then, the sound collection module 50 determines whether or not the module has received a request of sound collection (step S33). In the step S33, the sound collection module 50 determines whether or not the module has received a request of sound collection from an external terminal such as an operation terminal or computer.

In the step S33, if determining that the sound collection module 50 has not received a request of sound collection (NO), the sound collection module 50 repeats this determination process until receiving the request.

If determining that the sound collection module 50 has received a request of sound collection (YES) in the step S33, the sound collection module 50 starts to collect a marginal sound (step S34). In the step S34, when starting to collect a marginal sound, the sound collection module 50 may also start to take images such as still or moving images around the wireless aircraft. In this case, when stopping collecting a marginal sound, the sound collection module 50 only has to stop taking the images.

The antiphase sound wave generation module 40 outputs the antiphase sound wave generated in the step S32 to around a microphone (step S35).

The sound collection module 50 synthesizes the sound wave of the collected marginal sound with the antiphase sound wave generated in the step S32 (step S36), eliminates the motor-rotating sound from the collected marginal sound, and generates sound data (step S37).

The data transmission module 20 transmits the sound data generated in the step S37 to the external terminal (step S38).

The sound collection module 50 determines whether or not the module has received a request of end-of-sound collection (step S39). In the step S39, the sound collection module 50 determines whether or not the module has received a request of end-of-sound collection from an external terminal. In the step S39, the wireless aircraft 10 may generate a request of end-of-sound collection based on a previously set program, etc., in the case, for example, where a predetermined time has passed since sound collection is started or where the wireless aircraft has moved a predetermined distance since sound collection is started.

In the step S39, if determining that the sound collection module 50 has not received a request of end-of-sound collection (NO), the sound collection module 50 repeats the steps from S35 to S38.

If determining that the sound collection module 50 has received a request of end-of-sound collection (YES) in the step S39, the sound collection module 50 stops collecting any sounds (step S40).

To achieve the means and the functions that are described above, a computer (including CPU, an information processor, and various terminals) reads and executes a predetermined program. For example, the program is provided in the form recorded in a computer-readable medium such as a flexible disk, CD (e.g. CD-ROM), and DVD (e.g. DVD-ROM, DVD-RAM). In this case, a computer reads a program from the recording medium, forwards and stores the program to and in an internal or an external storage, and executes it. The program may be previously recorded in, for example, a storage (recording medium) such as a magnetic disk, an optical disk, and a magnetic optical disk and provided from the storage to a computer through a communication line.

The embodiments of the present invention are described above. However, the present invention is not limited to the above-mentioned embodiments. The effects described in the embodiments of the present invention are only the most preferable effect produced from the present invention. The effects of the present invention are not limited to those described in the embodiments of the present invention.

### REFERENCE SIGNS LIST

10 Wireless aircraft

What is claimed is:

1. A wireless aircraft having a motor and a propeller, the motor rotating the propeller, comprising:
an antiphase sound wave generation unit that collects a motor-rotating sound from the motor and that generates an antiphase sound wave against the collected motor-rotating sound;
a microphone unit that collects a marginal sound; and
a noise cancellation unit cancels noise by synthesizing the antiphase sound wave against the collected motor-rotating sound with the marginal sound collected by the microphone unit.

2. The wireless aircraft according to claim 1, wherein the antiphase sound wave generation unit generates an antiphase sound wave against a previously stored motor-rotating sound.

3. A method of cancelling noise executed by a wireless aircraft having a motor and a propeller, the motor rotating the propeller, comprising the steps of:
collecting a motor-rotating sound from the motor and generating an antiphase sound wave against the collected motor-rotating sound;
collecting a marginal sound; and
cancelling noise by synthesizing the antiphase sound wave against the collected motor-rotating sound with the marginal sound collected by the microphone unit.

4. A computer program product for use in a wireless aircraft having a motor and a propeller, the motor rotating the propeller, comprising a non-transitory computer usable medium having a set of instructions physically embodied therein, the set of instructions including computer readable program code, which when executed by the wireless aircraft causes the information processing unit to:
collect a motor-rotating sound from the motor and generate an antiphase sound wave against the collected motor-rotating sound;
collect a marginal sound; and
cancel noise by synthesizing the antiphase sound wave against the collected motor-rotating sound with the marginal sound collected by the microphone unit.
